(19) United States
(12) Patent Application Publication
(10) Pub. No.: US 2025/0347600 A1
(43) Pub. Date: Nov. 13, 2025

(54) Continuous Surface Inspection using a Roller Sensor

(71) Applicant: The Board of Trustees of the University of Illinois, Urbana, IL (US)

(72) Inventors: Mohammad Amin Mirzaee, Urbana, IL (US); Arpit Agarwal, Champaign, IL (US); Wenzhen Yuan, Champaign, IL (US)

(21) Appl. No.: 19/074,045

(22) Filed: Mar. 7, 2025

Related U.S. Application Data
(60) Provisional application No. 63/646,197, filed on May 13, 2024.
(60) Provisional application No. 63/729,919, filed on Dec. 9, 2024.

(51) Int. Cl. G01N 3/06; G01N 3/42

(52) U.S. Cl. CPC G01N 3/068; G01N 3/42

(57) ABSTRACT

An example embodiment includes a system. The system includes at least one light source, a photosensor, an optical window, an elastomer with an outer face, and an opaque material. The opaque material partially covers the outer face of the elastomer. First emission light, emitted by the at least one light source, passes through at least a portion of the optical window and interacts with the opaque material to produce a first interaction light. The photosensor receives at least part of the first interaction light to form a first image. An object applying a first pressure to the elastomer produces an indented region that affects an amount or a direction of first interaction light received by photosensor. The first image indicates one or more features of the object.

### CROSS-REFERENCE TO RELATED APPLICATIONS

The present application is a non-provisional patent application claiming priority to U.S. Provisional Patent Application No. 63/646,197, filed May 13, 2024, and U.S. Provisional Patent Application No. 63/729,919, filed Dec. 9, 2024, the contents of which are hereby incorporated by reference.

### STATEMENT REGARDING FEDERALLY SPONSORED RESEARCH OR DEVELOPMENT

This invention was made with government support under 2348839 awarded by the National Science Foundation. The government has certain rights in the invention.

### BACKGROUND

Ensuring surface quality during manufacturing is essential for maintaining product integrity and operational efficiency. As manufacturing automation expands, the demand for efficient, real-time surface assessment solutions continues to grow, particularly in sectors dealing with large machinery and metal components to identify defects such as cracks, scratches, or deformations. It also helps to prevent failures and maintain product quality in critical components, especially in aerospace, automotive, and medical industries, where defects can lead to catastrophic consequences. Various technologies have been developed for surface inspection, including laser scanning and structured light systems, which offer high accuracy but can be expensive and complex. Vision-based tactile sensors (VBTS) provide a cost-effective alternative by using optical sensing to capture fine surface details. These sensors have been widely used in robotics and detailed surface analysis, but traditional designs have limitations in sensing large areas. These limitations highlight the ongoing need for innovative solutions that enable reliable, high-resolution surface inspection in automated environments.

### SUMMARY

In a first aspect, the disclosure describes a system. The system includes at least one light source, a photosensor, an optical window, an elastomer with an outer face, and an opaque material. The opaque material partially covers the outer face of the elastomer. First emission light, emitted by the at least one light source, passes through at least a portion of the optical window and interacts with the opaque material to produce a first interaction light. The photosensor receives at least part of the first interaction light to form a first image. An object applying a first pressure to the elastomer produces an indented region that affects an amount or a direction of first interaction light received by photosensor. The first image indicates one or more features of the object.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1A shows a sensor, according to example embodiments.

FIG. 1B shows the sensor of FIG. 1A mounted on a robotic arm, according to example embodiments.

FIG. 2A shows an exploded view of a sensor, according to example embodiments.

FIG. 2B shows several perspectives of a sensor, according to example embodiments.

FIG. 2C shows a bottom view of a sensor, according to example embodiments.

FIG. 2D shows a bottom view of a sensor, according to example embodiments.

FIG. 2E shows a sensor coupled to a motor, according to example embodiments.

FIG. 2F shows several perspectives of a sensor with a suspension mechanism, according to example embodiments.

FIG. 2G shows the sensor of FIG. 2F on different surfaces, according to example embodiments.

FIG. 2H shows several perspectives of a sensor with ellipsoid wheels, according to example embodiments.

FIG. 2I shows the sensor of FIG. 2H within a pipe, according to example embodiments.

FIG. 2J shows several perspectives of a sensor with a belt-tightening mechanism, according to example embodiments.

FIG. 3 shows an optical configuration, according to example embodiments.

FIG. 4 shows single-frame sensing capabilities on objects, according to example embodiments.

FIG. 5 shows reconstruction accuracy, according to example embodiments.

FIG. 6 shows large surface reconstruction results, according to example embodiments.

FIG. 7 shows a method for contact force and angle estimation, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### I. Overview

Automated surface inspection during quality control of manufacturing processes has been demanded since the late 20th century to prevent damage to production. Subsequently, as industries continue to grow and adopt automation, the demand for reliable solutions has intensified. Whether for quality control, maintenance, or safety purposes, accurate surface assessment plays a role in ensuring operational efficiency and product quality. Many industries involving large-scale manufacturing machinery and the production of large metal components, like aircraft parts, face challenges such as vibration and debris from foreign objects, high temperatures, friction, and corrosion in the production and maintenance stage of the components. Such factors can contribute to fatigue and failure of components, adversely affecting system performance and resulting in irreparable damages. Therefore, each industry may have specific maintenance requirements, such as surface inspections, to guarantee safe operations. Accordingly, the need for an automated system that can provide continuous, real-time feedback on the condition of surfaces, ranging from smooth to irregular and textured shapes, grows. Additionally, systems may need be sensitive enough to catch detailed information such as tiny defects on the surface.

As a low-cost and fast technique, VBTS have shown promising performance in detailed sensing of objects by using high-resolution camera sensors. They have can be used in robotic tasks for dexterous manipulation, and high-resolution surface geometry reconstruction. Such sensors can incorporate a camera and a clear elastomeric membrane coated with a reflective material. The reflective layer deforms, and the camera captures the light variations through the elastomer. A rigid support can be attached to the elastomer to press it onto the target surface, imprinting fine surface details into the reflective membrane.

Various systems can be developed for sensing detailed information on the surface. For resolutions down to 0.1 mm, systems based on structured light or laser scanning complicated and expensive techniques can be used. However, for capturing finer detail, complicated and expensive techniques may be needed. Also, many existing systems can have small sensing areas limiting them to attain only local tactile information and may not enable continuous sensing.

As one of the oldest techniques to measure surface 3D topography, mechanical profilometers have been a reliable tool for high-precision measurements. However, such a point-by-point approach is time-consuming and less effective for complex geometries or large surfaces. Non-contact optical methods like laser scanning and structured light scanning have become prevalent due to their noncontact approach, which can allow for faster data acquisition and broader coverage. These optical methods can achieve resolutions down to 0.1 mm, although they often struggle with highly specular and transparent surfaces and changing environmental lighting.

For applications requiring finer resolution, techniques such as white light interferometry, confocal microscopy, scanning electron microscopy, and atomic force microscopy (AFM) are possible. These methods can achieve submicron to nanometer-scale resolution, which may offer unmatched detail. However, their complexity, longer processing time, and cost may be significant drawbacks. This could limit their use to specialized applications and making them less practical for large-scale scanning.

In contrast to other surface scanning techniques, vision-based tactile sensing can offer a robust solution, capable of accurately measuring surface conditions across diverse material types and lighting conditions while being low-cost and easy to operate. The high-resolution sensors can boast spatial resolution down to several micrometers, acquiring detailed information about surface topography. They may employ cameras and image processing algorithms to analyze the deformation of a soft, clear material, such as silicone elastomers, pressed against a surface. The surface information, such as texture, can be captured in the image using the reflective layer on the elastomer.

VBTSs can have a rigid, transparent supporting plate attached to the silicone, pressing it to the target surface. Elastomer's surface traction with the target object and its constraint to the supporting plate may prevent these traditional sensors from sliding on the surface while distorting the image signals and tearing the elastomeric membrane. Therefore, for large-scale surfaces, these sensors may need to be repeatedly pressed on a small area, lifted, and moved to another location potentially making these sensors inefficient for continuous scanning and large surface inspection applications.

Some designs may overcome the limitations of conventional VBTSs in continuous sensing. For example, a cylindrical VBTS that may be able to roll around its center axis while maintaining contact with the surface. The continuous rolling motion may boost the large surface scanning efficiency. The sensor may be mapped an 8 cm×11 cm flat surface texture without a 3D reconstruction in 10 seconds. Robot in-hand manipulation of small objects using rolling fingertips may also be possible. Employing high-resolution tactile sensing on a rolling finger may provide sufficient continuous tactile feedback for in-hand manipulation and reconstruction of small surface geometries.

Large surface reconstruction using cylindrical sensors may be challenging as the tactile information corresponds to varying depth levels. It may be possible to use an image fusion method for cylindrical VBTSs that extracts relevant information associated with various contact depths in the frequency domain and subsequently integrates these distinct characteristics through a differential fusion process. It may be suggested that such a method could have enhanced performance for small indentation compared to the motion distance sampling stitching method.

Previous efforts exploring cylindrical roller design may have issues because their optical and mechanical structures exhibit limitations in surface measurement accuracy and speed. The cylinder intersection with a surface produces narrow tactile information in each frame with varying indentation depths, may be a big sensing challenge for accurate large surface reconstruction. Also, a larger sensing area may require a much larger cylinder, which may be inefficient.

### II. Example Systems and Devices

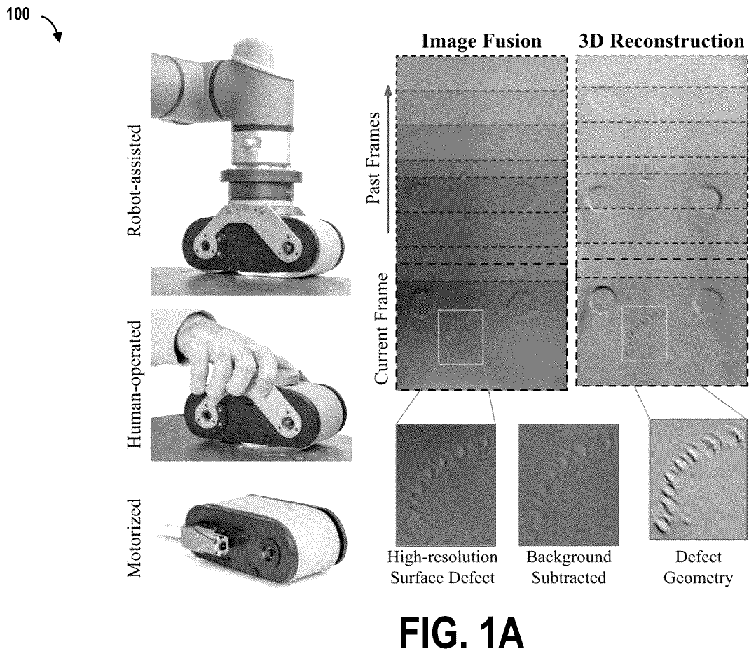

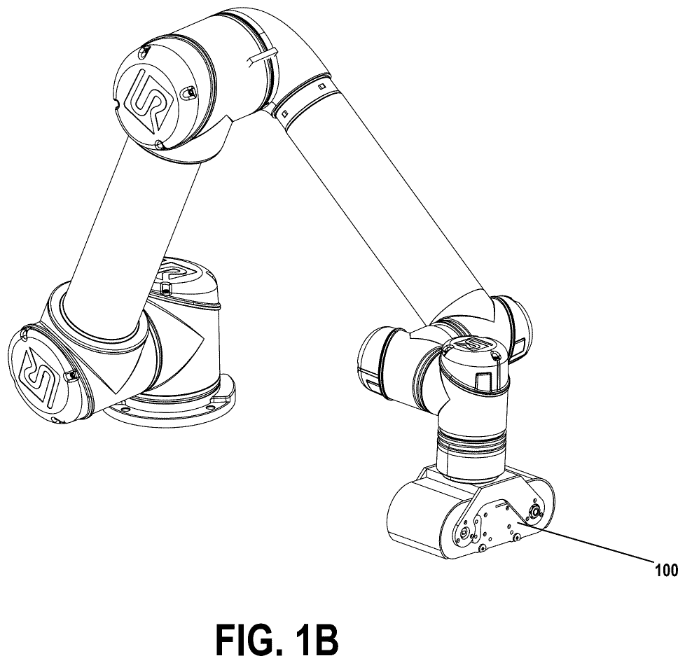

FIG. 1A shows a sensor 100, according to example embodiments. As shown, the sensor could be mounted on a robot and/or robotic arm (e.g., a UR5 robot, or a robotic arm as shown in FIG. 1B) for continuous surface reconstruction to detect defects. One application of such defect detection is in the manufacturing of metal components such as aircraft parts, as discussed above. In some embodiments, the sensor 100 could be motorized to scan the surface on its own. In some embodiments, the sensor 100 could be used as a hand-held device to scan the target surface.

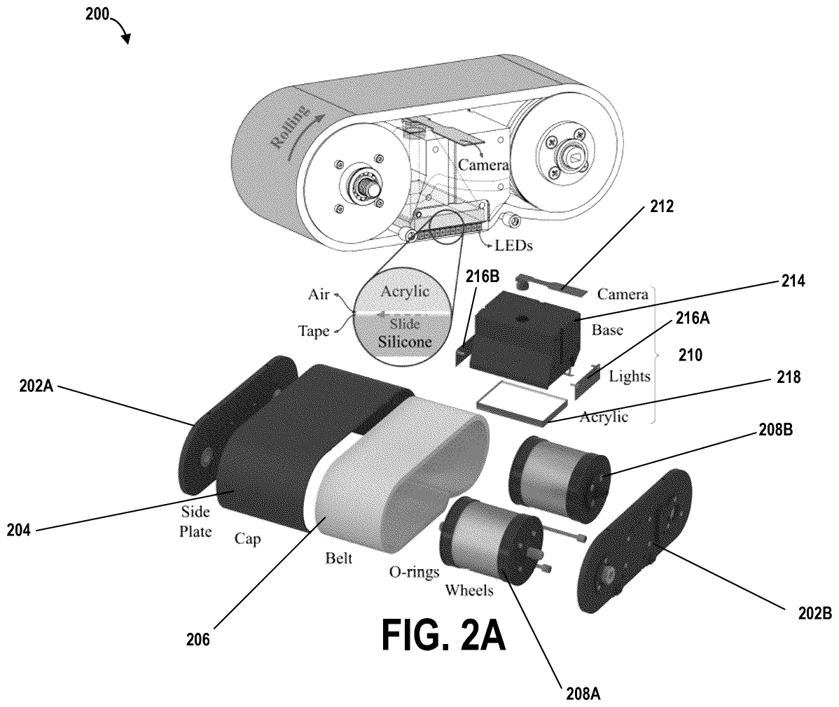

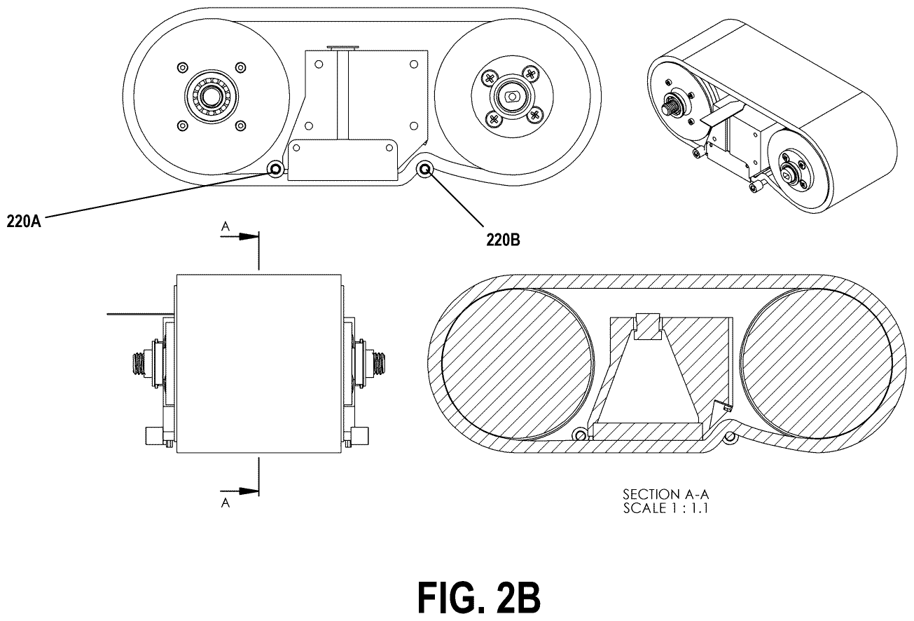

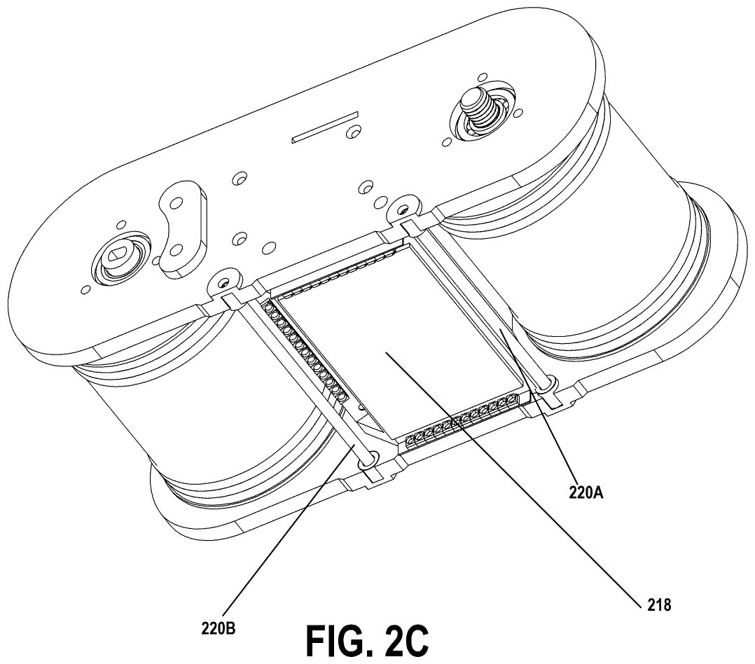

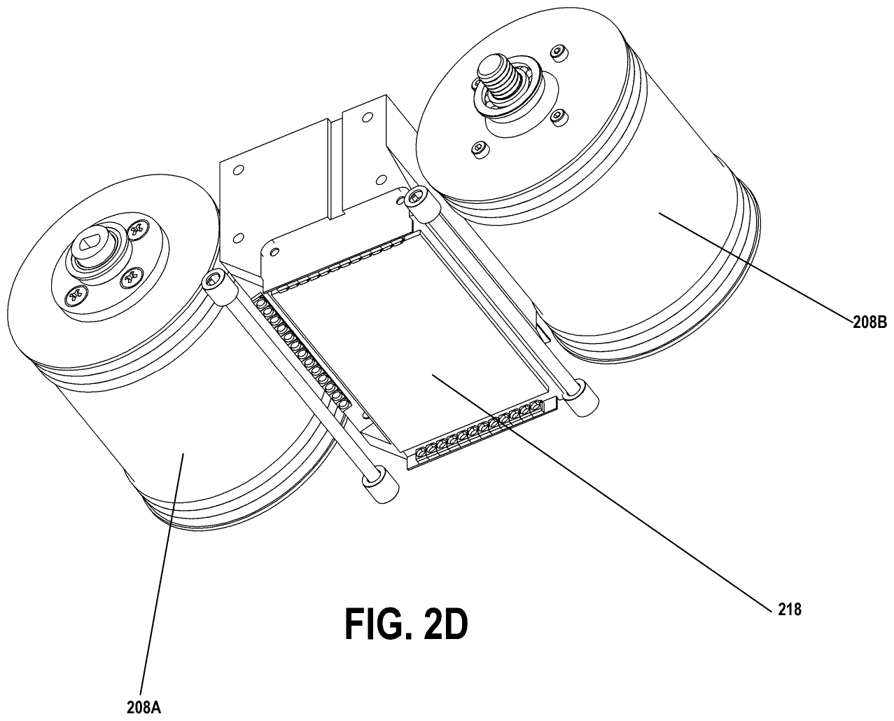

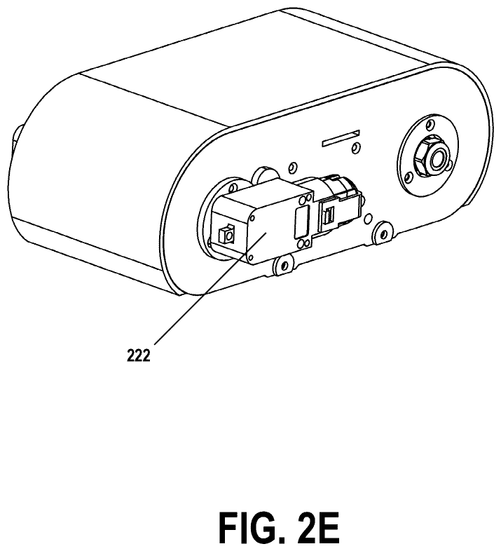

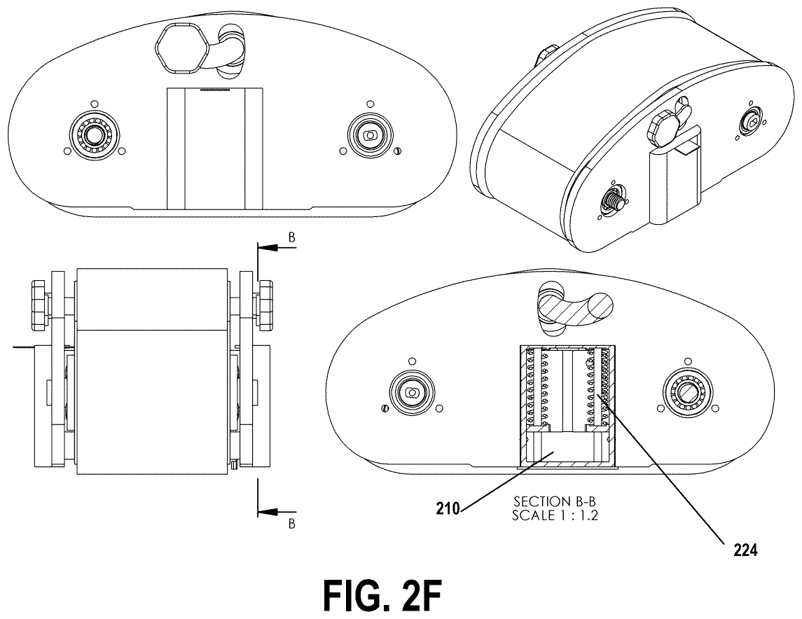

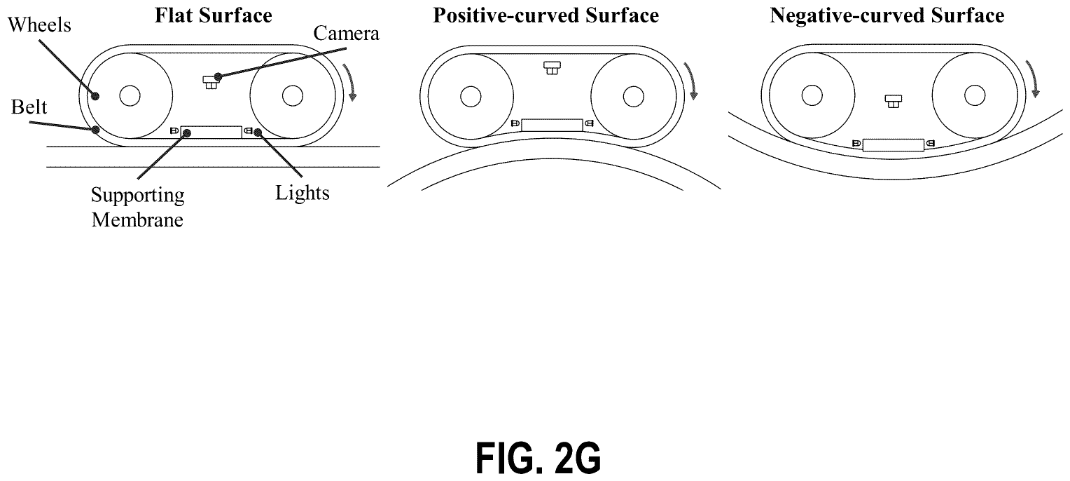

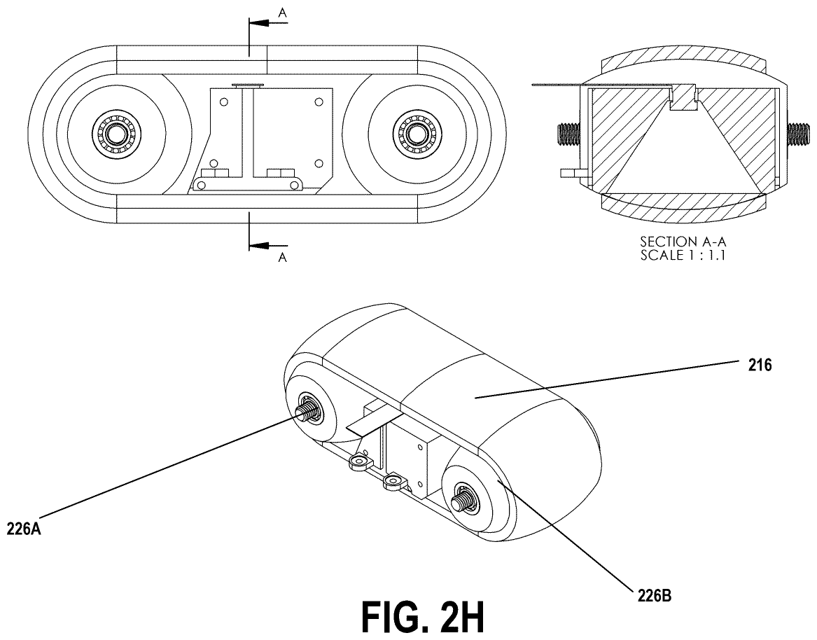

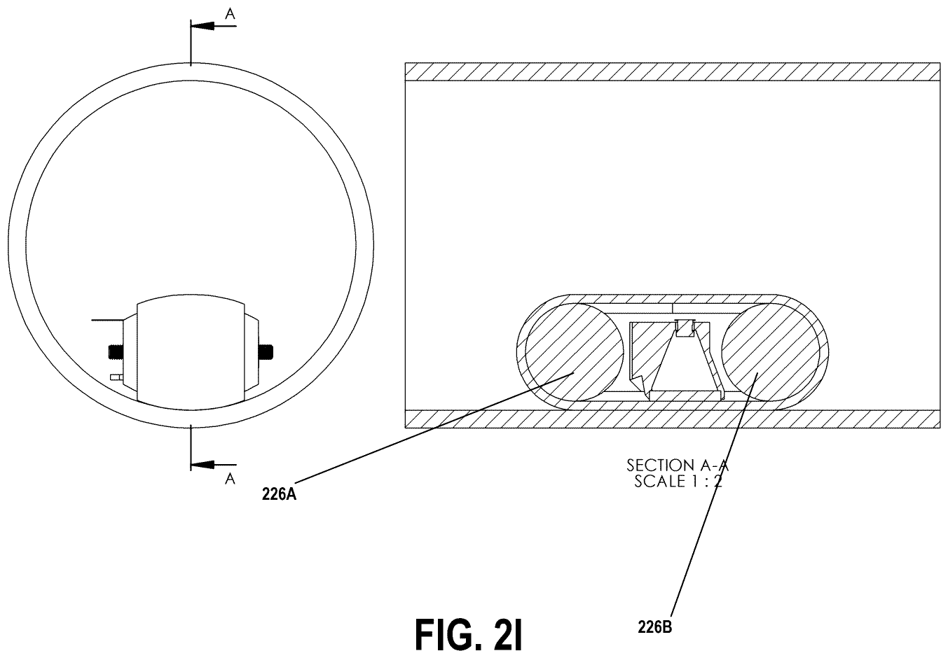

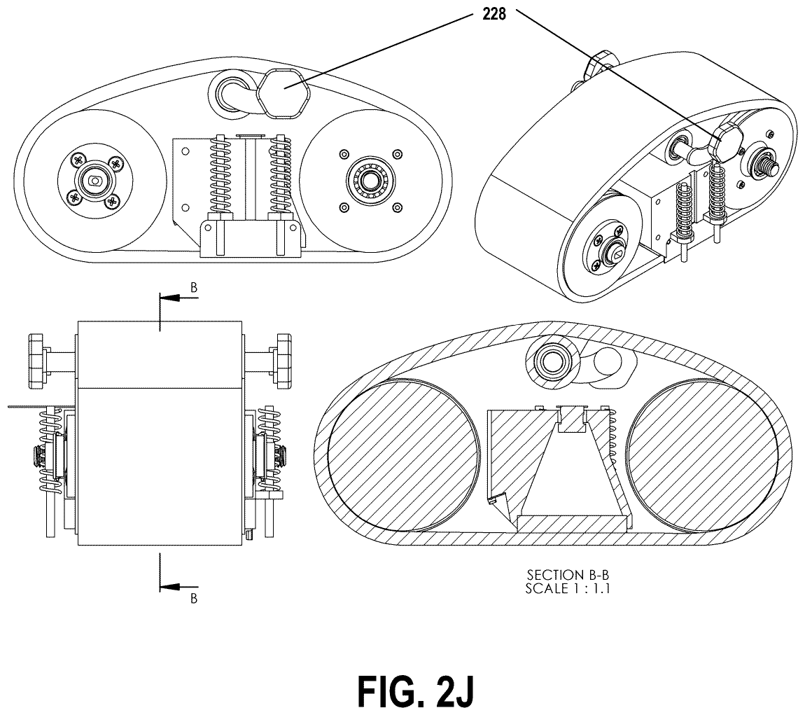

FIG. 2A shows an exploded view 200 of a sensor (e.g., the sensor 100), according to example embodiments. As seen in FIG. 2, several components are highlighted and will be described in further detail below.

As shown in FIG. 2A, the sensor in the exploded view 200 may include a two-wheel structure with a belt 206 made of sensing materials. When scanning a surface, the belt may roll over the wheels 208A and 208B while other optical components, such as an optical base unit 210, are fixed between the two wheels to sense the contact information in the area. The sensor may also include side plates 202A and 202B to hold the wheels and belt in place, as well as a cap 204 surrounding portions of the belt. The cap 204 may be included to protect the portions of the belt 206 that are not in contact with a surface for analysis. The belt 206 may include an elastomer, and such an elastomer may include silicone rubber, polyurethane, plastisol, thermoplastic elastomer, natural rubber, polyisoprene, or poly vinyl chloride. Other flexible belt materials and/or combinations of materials are possible and contemplated.

While a two-wheel example is shown in FIG. 2, this is merely for demonstrative/explanatory purposes; other numbers of wheels are possible in other embodiments. In some embodiments, the belt 206 may include one or more markers. These markers may aid in the operation of the sensor. For instance, two rows of black markers may be disposed near the edge of the belt to provide visual reference to the frame transformation and contact forces. This design may enable continuous sensing of surfaces while maintaining a large yet uniform contact area.

The optical base unit 210 may include several components, including a camera 212, base unit housing 214, lights 216A and 26B, and an acrylic layer 218. In some embodiments, the optical base unit 210 may include an optical window as described herein. A sensing region may be the area between the two wheels where acrylic layer 218 and the belt 206 overlap, as shown in the inset in FIG. 2. In some embodiments, may be beneficial for there to be minimal friction between the layers in the sensing area to facilitate the motion of the belt 206. As elastomers stick to a variety of surfaces, including acrylic, it may be beneficial to attach a flexible transparent layer (e.g., tape) to the inner surface of the belt 206, which has low friction with the acrylic and facilitates the belt's motion without impairing the rolling mechanism. The separation of elastomer and acrylic using the intermediate layer may introduce a thin air gap. The air gap may affect the sensor's optical performance. The lights 216A and/or 216B may be LEDs in some embodiments. In some embodiments, the optical base unit may include a wireless communication device which may be configured to transmit data. This data may be the data received by the camera 212. The wireless communication device may be configured to transmit data using a wireless communication protocol such as Bluetooth or Wi-Fi.

The outer surface of the belt 206 may be coated with reflective in some embodiments. The sensor may need to be pressed onto the surface to imprint the surface detail into the reflective layer. Accordingly, the wheels 208A/208B may apply the initial force through their weight. In some embodiments, the wheels 208A/208B may be made of aluminum. In contrast to the rigid support, the wheels may need to have adequate friction with the belt; otherwise, the belt and the wheels may not be mechanically coupled, which may cause them to slide on each other and hindering the overall motion. To increase friction, O-rings made of a material such as rubber may be added to the side of the wheels 208A/280B.

In some embodiments, the system may include one or more rods (e.g., rods 220A/220B in FIG. 2B) rotatably connected to the outer face of the elastomer. The rod may cause a deformation in the elastomer that affects the amount or the direction of the first interaction light received by the photosensor.

Other example views of a sensor is shown in FIGS. 2C and 2D, which each depict a bottom view of the sensor without the side plates 202A/202B and belt 206. The acrylic layer 218 and rods 220A/220B can be seen clearly from this perspective, as shown.

As an additional option to use the sensor as the end-effector of a robot, the sensor may be able to be self-driven on a surface like a small vehicle. This could be achieved by adding one or more motors (e.g., DC motors, servo motors, step motors) on the wheels. An example of this is illustrated in FIG. 2E, showing a side view of a sensor (e.g., sensor 100) with a motor 222 coupled to one of the wheels. In other embodiments, a motor may be attached to each of the wheels.

FIG. 2F depicts an embodiment of a sensor in which the optical base unit 210 is coupled to a suspension mechanism 224. As shown, the suspension mechanism 224 may include one or more springs that enable the optical base unit 210 to move up and down and thus adapt to variations in motion as well as the surface. Examples of this motion are depicted in FIG. 2G—as shown, the suspension mechanism 224 allows components of the optical base unit 210 (e.g., lights 216A/216B—“lights” in FIG. 2G) to move as the belt 206 flexes according to the shape of the surface. For instance, the suspension may move upwards when the sensor is used on a positive-curved surface, while the suspension may move downwards when the sensor is used on a negative-curved surface.

Another example of a sensor being used on a curved surface is shown in FIGS. 2H and 2I. In FIG. 2H, an embodiment of a sensor using ellipsoid wheels 226A/226B is shown from several perspectives. This wheel shape may allow the belt 206 to flex or otherwise conform to curved surfaces. One application of this could be using a sensor within a pipe, as shown in FIG. 2I. As the sensor moves down the pipe, the ellipsoid wheels 226A/226B conform the belt 206 closer to the shape of the pipe, which may improve the performance of the sensor.

A sensor may also include a mechanism for tightening the belt 206 such that it molds closer to both the surface being sensed by the sensor as well as the acrylic layer 218. FIG. 2J depicts several perspectives of a sensor with a belt tightening mechanism 228.

In some embodiments, a system is provided. The system may include at least one light source (e.g., lights 216A/216B), a photosensor (e.g., camera 212), an optical window (e.g., included in optical base unit 210), an elastomer with an outer face (e.g., belt 206), and an opaque material (e.g., acrylic layer 218). In some embodiments, the opaque material partially covers the outer face of the elastomer, and first emission light, emitted by the at least one light source, passes through at least a portion of the optical window and interacts with the opaque material to produce a first interaction light. In some embodiments, the photosensor receives at least part of the first interaction light to form a first image. In some embodiments, an object applying a first pressure to the elastomer produces an indented region that affects an amount or a direction of first interaction light received by photosensor. In some embodiments, the first image indicates one or more features of the object.

In some embodiments, the elastomer is not connected to the optical window.

In some embodiments, the outer face of the elastomer comprises a plurality of markers. In some embodiments, the markers may be configured to indicate contact angle or force.

In some example embodiments, the mechanical components enabling the motion may include the belt and the wheel system. In other words, the system described above may include a transmission system, which may include a plurality of wheels, and an elastomer may be arranged as a continuous band around at least a portion of each wheel (e.g., to form the belt 206). In some embodiments, the plurality of wheels may include a first wheel and a second wheel. In some embodiments, the first wheel comprises a first outer surface, wherein a first ring partially encloses the first wheel, wherein the second wheel comprises a second outer surface, wherein a second ring partially encloses the second wheel; and wherein the first ring and the second ring are removably connected to the elastomer. In some embodiments, the wheels may comprise a deformable material (e.g., a soft material or filled with air or other fluid)

In some embodiments, a transmission system for the sensor system may include one or more motors coupled to the wheels.

In some embodiments, a transmission system for the sensor system may include a plurality of magnets, wherein at least one of the plurality of magnets is coupled to the elastomer, and wherein at least one of the plurality of magnets is coupled to the wheels.

In some embodiments, a transmission system for the sensor system may include a belt portion coupled with at least one sprocket of the first wheel or the second wheel, wherein the belt portion comprises at least one of a flat belt, a V belt, a round belt, or a toothed belt.

In some embodiments, a transmission system for the sensor system may include a chain coupled with at least one sprocket on the first wheel or the second wheel.

In some example embodiments, a physics-based simulation methods could be used to optimize the VBTS design process and generate tactile images before fabrication. This method could be used to design the system's optical system. The simulation could be implemented in Blender (e.g., version 4.1.0) using the available optical parameters for the lights and surface properties.

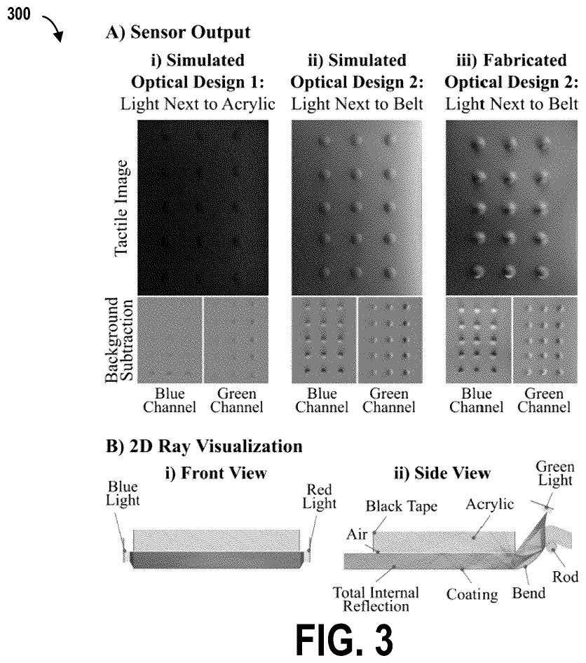

FIG. 3 shows an optical configuration 300, according to example embodiments. As shown in FIG. 3A, the optical system could be enhanced by changing the light locations in simulation to improve the light intensity and contrast over the entire sensing area, which highly matched the real sensor image. As shown in FIG. 3B, there may be a simplified representation of the light placement. A thin air gap between the belt and acrylic may result in total internal reflection.

In some example embodiments, light sources may be placed next to the clear acrylic illuminating from the sides of sensors. Accordingly, users may start with the same placements for the light sources in the simulation. Using such a configuration in may generate dark images with poor information after background subtraction. This issue may be caused by the elastomer-acrylic separation and/or introducing foreknown layers of clear tape and air into the design. This may result in total internal reflection (TIR) in the acrylic membrane, which may result in poor illumination in terms of intensity and contrast to the sensing surface.

In example embodiments, it may be possible to enhance the optical design by adjusting the light source locations. A beneficial design may result in improved lighting. In such example embodiments, the real sensor image may highly match the simulation results. The red and blue light sources may be placed on the side of the belt at the contact location. For the green light, it may be possible to use a small rod with needle bearings to bend the belt next to the acrylic while putting the green light at a specific angle to illuminate the surface. Adding the bend to the belt may enhance the green light illumination over the entire area both in terms of intensity and contrast. Green rays may travel through the elastomer and bounce back from the coating layer into the sensing area.

In some example embodiments, the system may be modified to incorporate optical system requirements. Optical components may be assembled in a single base for consistent reading in case of disassembling other components. The overall dimensions of the sensor could be 175 mm×80 mm×65 mm (L×W×H). The sensing area of the sensor could be 40 mm by 60 mm, which could allow reconstruction of relatively flat surfaces. However, these measurements are merely given as examples; other dimensions are possible in some embodiments.

In some example embodiments, the belt can be fabricated from Silicone XP-565. The hardness of the cured silicone could depend on the mixing ratio of part A and part B. Accordingly, the belt could be made from two layers of silicone that varied in hardness. A soft layer may increase sensitivity and a hard layer may enhance adhesion to the intermediate layer. The belt can be cast in a flat mold (e.g., 1:7 and 1:16 ratios for hard and soft layers, respectively) and can be coated with diffusive aluminum powder (or other reflective powders with varying specularity). To protect the coating, a 16:1:32 ratio of part A, part B, and Novacs Matte could be mixed and could be applied to the surface. However, these materials and processes are merely given as examples; use of other materials is possible in some embodiments. Two lines of dot markers on belt edges could be laser engraved to serve as a position encoder and determine the surface contact condition. Markers could have varying intervals to prevent aliasing in displacement measurement.

In some example embodiments, wide clear crystal tape could be used as the intermediate layer. Clear tape may be thin and flexible enough to bend over the wheels while having a stiff and slippery surface on the acrylic side. Use of other materials is possible to attach or deposit a slippery layer on the belt in some embodiments. The belt's ends could be attached to one another using Sil-Poxy glue (Smooth-On) to form a continuous belt. The rigid support plate could be a rectangle-shaped clear acrylic with a thickness of 6 mm. In some example embodiments, narrow printed circuit boards could be designed for soldering LEDs in parallel to match the light sources used in a simulation step. This could mean that the circuit resistance value for each color could be adjusted to match the light intensity in the simulation. Other components of the system could be 3D printed with PLA.

In some example embodiments, a large-scale surface reconstruction method could use one of the systems described herein. In such a system, as the belt rolls over textured 3D surfaces, it may capture tactile images, which can be used to estimate the local surface geometry. The sensor's frame-to-frame planar movement could be determined and the local geometries could be composed into a global 3D shape.

In example embodiments, surface normal estimation can be performed via the photometric stereo method. Surface normal maps can be predicted from tactile images collected by the system. For example, an 8 mm metal ball can be pressed against the system's sensing region at 143 different locations. The contact circles on these tactile images may be manually labeled, and the ground truth normal direction within these regions may be computed.

Using these data, a 3-layer MLP (128-32-32) may be trained that inputs each pixel's color and coordinates (RGBXY) to predict surface gradients (gₓ, g_{y}). During testing, surface gradients for each pixel can be predicted and converted into surface normals n\hat{ }, forming the surface normal map. Here, n\hat{ }=n/∥n∥| and n=[gₓ,g_{y},−1].

In some example embodiments, the measurements from a series of tactile images generated when the sensor is rolling on the surface may be stitched together to get the shape of a larger surface. A challenge in the process may be matching the pixels with the real surface location from different frames. The sensor's planar translational movement between frames may be estimated by applying optical flow to the surface normal map derived from the tactile images. With the initial frame as a reference, the global pose of each frame may be obtained by composing these estimated frame-to-frame movements. The surface normal map of the entire scanned region may be estimated by registering each local normal map to the global map using the estimated global poses and averaging the overlapping regions. The surface height map of the entire scanned region may be estimated through Poisson integration of the global normal map.

Optical flow may work well on tactile images of a surface with non-repeating texture and relatively small motion. To enable sensing with faster motion on repeating textured or non-textured surfaces, side markers may be used as a position encoders and the position fed as the initial displacement for optical flow. Markers may be the only useful information in the case of sensing a non-textured surface. This method may work well for a relatively flat surface. The combination of external pose information of the sensor to reconstruct the large-scale 3D shape may be required if the surface to scan is of a complicated 3D shape.

The surface marker motion in vision-based tactile sensors may be a component of measuring the applied force and torque to the sensor surface. Markers may also assist with robotic manipulation tasks for grasp stability and slip detection. The displacement of the side markers can provide useful information such as displacement, force, and contact angle. The cropped regions on the side of the tactile images could be considered the marker area, while the rest of the image can be used for geometry sensing. Markers may have different intervals to prevent mismatching. The locations of the markers can be obtained by applying a Blob filter to the red and blue channels of the marker areas next to the corresponding lights. Pixel displacement can be calculated by matching the marker pattern in two consecutive frames and using the measured displacement in the global surface reconstruction algorithm for coarse alignment of the frames before applying optical flow.

Contact force and angle can be useful feedback in closed-loop control algorithms to adjust the pressure and orientation of the sensor, which can improve reconstruction accuracy. Two splines can be fit to the detected markers on two sides and the position of 10 points (on each side) with fixed x-axis values can be used as the feature space to train the estimation models. Using this data two MLPs (512-256-128) can be trained. The MLPs may input the y values of 20 points. One model may output the x and y axes rotations, while the other one may output the normal force.

In some example embodiments, the system may be able to continuously measure surface details and contact conditions. This system can be tested on small objects in a static single frame and the 3D reconstruction performance can be evaluated by reporting accuracy over the sensing area. The system can be applied to evaluate large surface reconstruction performance by continuously moving the sensor over planar objects. The system may be mounted on a UR5 robot to perform transnational movements.

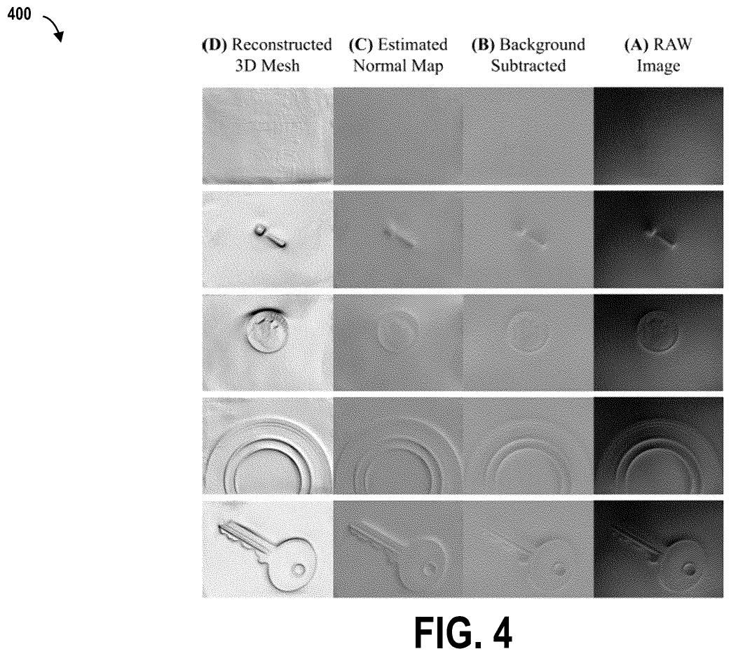

FIG. 4 shows single-frame sensing capabilities 400 on objects, according to example embodiments. These objects can include a Chinese Yuan bill, a screw, a coin, scotch tape, and a key. In these example embodiments, the system's tactile sensing performance may be determined by pressing the sensor over objects such as a key, scotch tape, coins, and cash. In such embodiments, it may be possible to obtain detailed surface information for a variety of geometries, from fine texture on a Chinese Yuan bill to a relatively large object, such as, a key.

Reconstruction accuracy can be determined by pressing a hex indenter with known dimensions in 143 different locations over the sensing area (13×11 grid). The hex surface normal can be calculated using the calibrated sensor, masking the indentation area, and calculating the average dot product of the masked hex with the ground truth normal. Using the dot product of the surface normal vectors as the accuracy metric may provide information about the alignment of the normal vectors which may directly affect the reconstructed mesh. The dot product values range from −1 to 1, which could correspond to the fully-aligned and opposite-direction vectors, respectively.

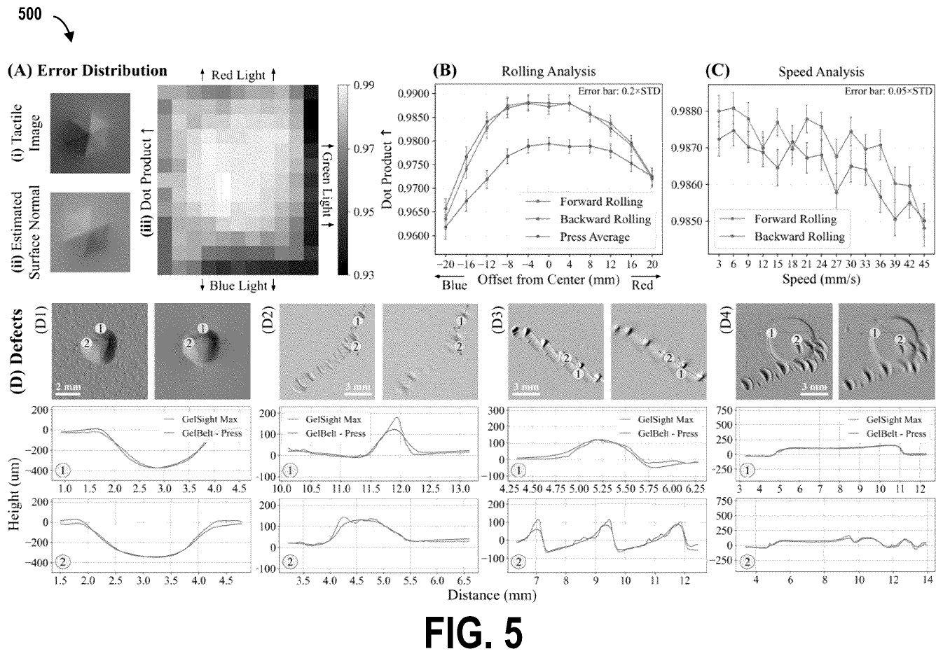

FIG. 5 shows reconstruction accuracy 500, according to example embodiments. As shown in FIG. 5A, a hex pyramid shape may be indented in multiple locations and to obtain the 2D normal estimation accuracy plot across 143 indentations. The units in the center of the frame may have the highest estimation accuracy, with the dot product value decreasing closer to the sides. The lowest accuracy may correspond to the light saturated units at the bottom right corner, adjacent to the green and blue lights.

Camera filters may detect R, G, B lights centered at approximately 660, 520, and 450 nm, and the used green and blue LEDs may have a much wider wavelength spectrum (20 nm) compared to red light (7 nm). The, possibly, closer wavelengths of blue and green lights plus the, possibly, the wider spectrum result in mixed signals in BG channels, may decrease sensitivity in the area close to the green and blue light.

Further, as shown in FIG. 5B, the system may be rolled over the same object to obtain the accuracy for different offsets from the image centerline. Moreover, as shown in FIG. 16C, rolling speed may affect sensor accuracy.

In addition, as shown in FIG. 5D, 3D mesh reconstruction comparisons may be performed across sensors with nanometer scale z-axis accuracy. The systems disclosed herein can be used for surface inspection in quality control and maintenance across various industries. This motivates 3D reconstruction of small defects on aircraft parts. The sensor's reconstructed mesh can be compared with that of another other sensor. The Iterative Closest Point (ICP) method could be used to align the 3D mesh of the two sensors. Five different defect surface profiles could be created on aircraft parts using each sensor and the results compared. As shown in FIG. 5D, both sensors can reconstruct the surface geometry of submillimeter dimensions with good accuracy. The system's performance may decline for sensing defects with sharp edges presenting a smoothed surface profile.

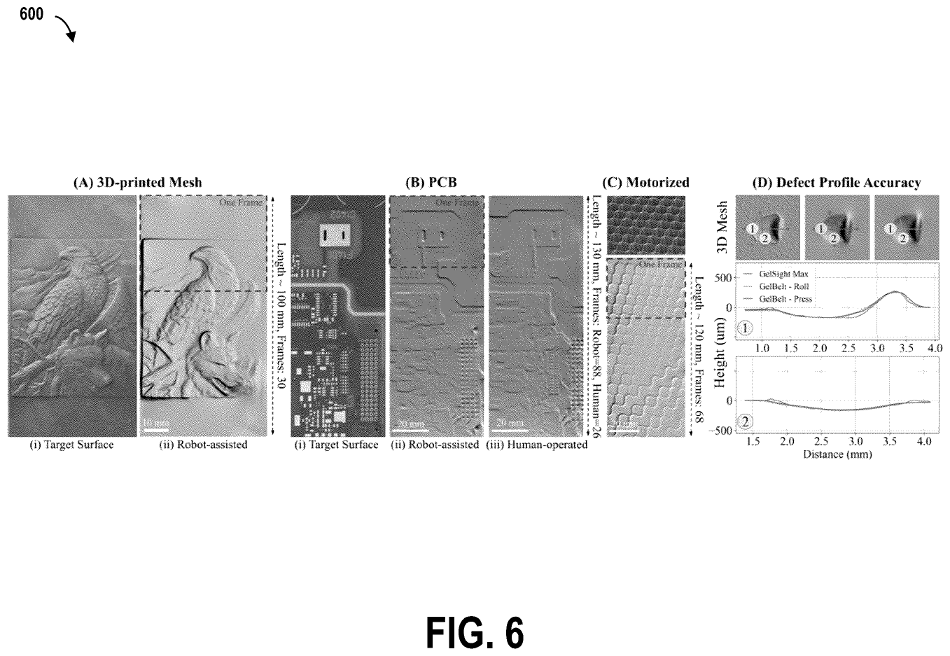

FIG. 6 shows large surface reconstruction results 600, according to example embodiments. FIG. 6A shows the surface of a detailed printed mesh. FIG. 6B shows the reconstruction of the PCB surface in robot-assisted and manual modes. The system's shape reconstruction accuracy on a static frame can be validated through experiments. Further, the system's global geometry reconstruction over a larger surface can be determined. FIG. 6A and 6B indicate reconstruction accuracy of the system, specifically, reconstructed 3D mesh of a printed mesh, printed using a Form 3+ printer, and a PCB, generated by continuously moving the system over the surface. The system may capture and stitch surface details, which may allow for accurate reconstruction of large surfaces. These results may also highlight the efficiency of the system in producing high-quality 3D surface meshes, which is beneficial in applications requiring rapid yet precise scanning of the surface.

In example embodiments, the global surface reconstruction's error distribution can be calculated by rolling the system over the same hexagonal pyramid geometry as described previously, with different offsets from the center of the image. The system achieves high accuracy with minimal deviations from the reference normal map. Also, similar to the single frame mode, higher estimation error may occur close to the blue light. This high performance further validates the effectiveness of the systems described herein in providing precise surface reconstructions, which may make them reliable tools for applications that demand accurate 3D modeling.

Sensor velocity can limit overall accuracy as it can control the number of frames for the same geometry and can increase the shear force applied to the sensing surface. The same procedure applied previously can be applied again while varying speeds, from 3 to 45 mm/s, for indentation at the center of the image. Lower speeds may result in higher accuracy of the surface normal estimation while capturing sharper detail of the surface. As the scanning speed increases, the error may rise with a much smoother estimation of surface detail, which may suggest a trade- off between speed and accuracy. The system described herein has a scanning rate that may be substantially higher than the maximum reported values for cylindrical sensors. This suggests that these systems provide fast yet accurate VBTS scanning systems. A higher frame rate and softer silicone can increase the scanning speed.

The system's movement has been carried out using a UR5 robot. In some example embodiments, a human operator can manually move the sensor over the surface instead of a robot. Experiments using this set-up could aim to assess the system's performance under more variable and less controlled conditions, thereby simulating a different real-world usage scenario. As depicted in FIG. 6B, the results may demonstrate that, despite the inherent inconsistencies introduced by manual operation, the sensor may be able to maintain a high level of accuracy in reconstructing the surface geometry.

FIG. 6C shows the results of using the system or sensor with attached motors for standalone surface sensing. The system can be motorized and rolled on a honeycomb laser bed. In addition, FIG. 6D shows the results of rolling on the aircraft defects has similar results to single-frame sensing.

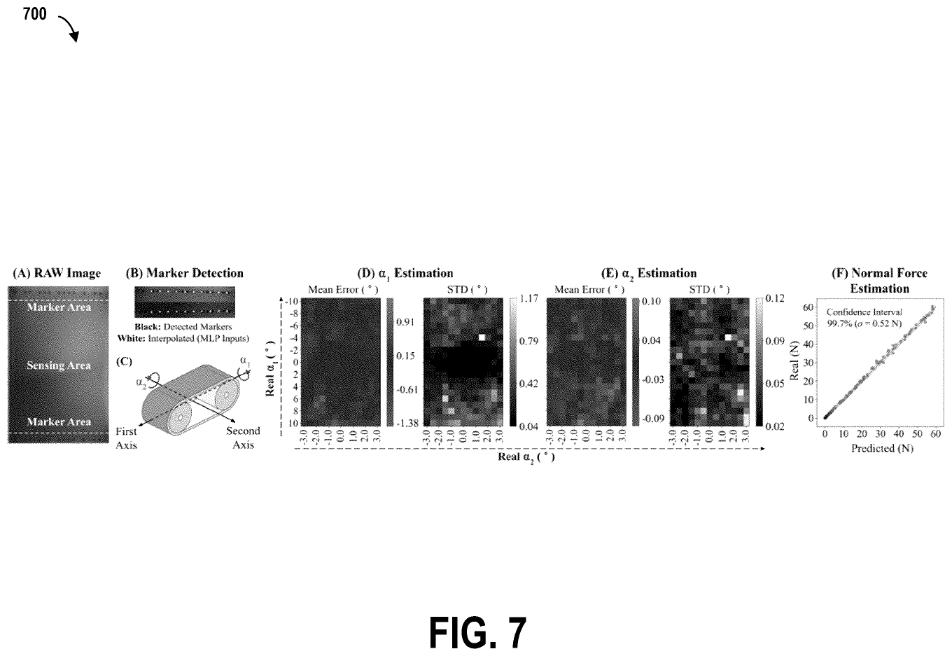

FIG. 7 shows a method for contact force and angle estimation, according to example embodiments. As seen in FIG. 7A, there may be marker areas on the side of the image. The markers can be detected using the blob dog function from the Scikit-image Python library.

As seen in FIG. 7B, splines may be fit to the detected markers and 2×10 points can be interpolated as model inputs. The detected markers can be shown with black dots and feature points can be shown with white dots.

As can be seen in FIG. 7C, there may be two rotation axes and a UR5 robot can be used. In some example embodiments, the sensor can be mounted on the robot's end effector and contact angles changed for example in the range of −3 to 3 degrees in the x-axis direction (wheelbase axis) and −10 to 10 degrees in the y-axis (wheel axis) with intervals of 0.5 and 1 degree, respectively. Normal force data could be collected using a force sensor mounted on the robot in full-contact mode. This, the contact force and angle data, acquisition could be iterated for example 35 times. After each cycle, the system could roll to get different marker locations. The collected data could be divided into train, validation, and test sets (60:20:20).

FIG. 7D and FIG. 7E show mean errors and standard deviation plots for two estimated angles. As seen in FIG. 7D and FIG. 7E, the model may be able to estimate the surface contact angle of both axes with good accuracy. The estimation error of the first axis may be higher compared to the second axis, while larger angles could correspond to larger errors.

FIG. 7F shows normal force prediction plots. These plots show that the force estimation model may be able predict the applied force with good accuracy over the entire range of the study with error of 1 N (95% confidence interval). Contact force and angle estimation results may highlight the applicability of the markers' motion as feedback in automated closed- loop scanning on curved surfaces.

Overall, the systems and sensor described herein can enable effective rapid scanning of the surface. Such systems and sensors can be designed, fabricated, and tested to reveal its applicability. Their mechanical design can be demonstrated by incorporating an elastomeric belt and two wheels enabling continuous motion on the surface. Such sensors and systems may be able to accurately capture surface texture, reconstruct the surface normal map and 3D mesh, and stitch them together. The qualitative and quantitative analyses using such systems and sensors may highlight the sensor's reliability and precision, which could be evidenced by the low reconstruction errors and the close alignment with the target object. Additionally, the systems and sensors could have a reconstructed surface mesh with five small defects could be compared with that of other sensors, supporting the accuracy and precision of the described systems and sensors. Other results may also suggest that reconstruction dot product accuracy can be maintained above 0.97 for scanning speeds of up to 45 mm/s.

Moreover, the design idea described herein may transcend the limitations of other sensors. The described system and sensor may be able to continuously scan the surface while maintaining large surface contact in each frame. It may be able to achieve this by uncoupling the elastomer and the rigid supporting membrane. The elastomer may function as a belt and may roll over at least two wheels or rods and may generate continuous tactile data. A methodology for surface normal estimation and stitching consecutive frames for surface 3D mesh reconstruction can be demonstrated. The surface reconstruction accuracy of the described systems and sensors can be described in experiments by the dot product of the estimated and reference surface normal maps, which could reveal excellent alignment, e.g., with an average dot product of more than 0.97 for both single-frame and global surface reconstruction. Also, the reconstruction accuracy of small surface defects can be compared with other sensors. Such results can further support the capability of the described systems and sensors to obtain high-resolution information on the surface.

In some example embodiments, markers can be added to the side of the belt to primarily act as a relative position encoder for frame alignment. The marker displacement field can be used to estimate contact normal force up to 60 N with an estimation error of about 1 N (confidence interval 95%), and surface angle ranging from −10 to 10 degrees and −3 to 3 degrees for roll and pitch with a maximum mean error of 1.38 and 0.1 degrees, respectively. The described systems and sensors may have mechanical and optical characteristics for rapid and accurate scanning of large surfaces and may be versatile for use in automated, manual, or self-driven setups, which could make it an ideal solution for a wide range of applications. The described systems and sensors may be scalable and it may be possible to use smaller versions as hand-held tools for rapid surface scanning in industries.

Each of the values above are merely given as examples to describe certain embodiments and should not be construed as limiting the scope of the disclosure.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
at least one light source;
a photosensor;
an optical window;
an elastomer with an outer face; and
an opaque material, wherein the opaque material partially covers the outer face of the elastomer, wherein first emission light, emitted by the at least one light source, passes through at least a portion of the optical window and interacts with the opaque material to produce a first interaction light, wherein the photosensor receives at least part of the first interaction light to form a first image, wherein an object applying a first pressure to the elastomer produces an indented region that affects an amount or a direction of first interaction light received by photosensor, and wherein the first image indicates one or more features of the object.

2. The system of claim 1, further comprising:
a rod rotatably connected to the outer face of the elastomer, wherein the rod causes a deformation in the elastomer that affects the amount or the direction of the first interaction light received by the photosensor.

3. The system of claim 1, wherein the elastomer is not connected to the optical window.

4. The system of claim 1, wherein the outer face of the elastomer comprises a reflective powder with selectable specularity.

5. The system of claim 1, further comprising:
a plurality of wheels, wherein the elastomer is arranged as a continuous band around at least a portion of a first wheel and a second wheel.

6. The system of claim 5, wherein the first wheel comprises a first outer surface, wherein a first ring partially encloses the first wheel, wherein the second wheel comprises a second outer surface, wherein a second ring partially encloses the second wheel; and wherein the first ring and the second ring are removably connected to the elastomer.

7. The system of claim 5, further comprising:
a transmission system, wherein the transmission system comprises a plurality of magnets, wherein at least one of the plurality of magnets is coupled to the elastomer, and wherein at least one of the plurality of magnets is coupled to at least one of the plurality of wheels.

8. The system of claim 5, further comprising:
a transmission system, wherein the transmission system comprises a belt portion coupled with at least one sprocket of at least one of the plurality of wheels, wherein the belt portion comprises at least one of a flat belt, a V belt, a round belt, or a toothed belt.

9. The system of claim 5, further comprising:
a transmission system, wherein the transmission system comprises a chain coupled with at least one sprocket on at least one wheel of the plurality of wheels.

10. The system of claim 5, further comprising a transmission system, wherein the transmission system comprises one or more motors mechanically coupled to at least one of the plurality of wheels.

11. The system of claim 10, wherein the one or more motors comprise at least one of a DC motor, servo motor, or stepper motor.

12. The system of claim 5, wherein at least one wheel of the plurality of wheels has an ellipsoid shape.

13. The system of claim 5, wherein at least one wheel of the plurality of wheels comprises a deformable material.

14. The system of claim 1, further comprising a suspension mechanism, wherein the suspension mechanism is configured to adapt the elastomer to a surface of the object.

15. The system of claim 1, further comprising a mechanism configured to tighten the elastomer.

16. The system of claim 1, wherein the outer face of the elastomer comprises a plurality of markers.

17. The system of claim 16, wherein the markers are configured to indicate at least one of contact angle or force.

18. The system of claim 1, wherein the elastomer comprises silicone rubber, polyurethane, plastisol, thermoplastic elastomer, natural rubber, polyisoprene, or poly vinyl chloride.

19. The system of claim 1, further comprising a wireless communication device coupled to the photosensor, wherein the wireless communication device is configured to transmit data received by the photosensor.

20. The system of claim 1, wherein a flexible transparent layer is disposed on an inner surface of the elastomer.
